(19) United States
(12) Patent Application Publication
(10) Pub. No.: US 2008/0194008 A1
(43) Pub. Date: Aug. 14, 2008

(54) Methods for Reducing Chlorine Dioxide Associated Corrosion

(76) Inventors: Hui Xu, Wake Forest, NC (US); Kim Bloomfield, Raleigh, NC (US); Jing Luo, Raleigh, NC (US)

Correspondence Address: NOVOZYMES NORTH AMERICA, INC., 500 FIFTH AVENUE, SUITE 1600, NEW YORK, NY, 10110, US

(21) Appl. No.: 11/911,205

(22) PCT Filed: Apr. 11, 2006
(86) PCT No.: PCT/US06/13429

§ 371 Date: Nov. 27, 2007

Related U.S. Application Data
(60) Provisional application No. 60/671,254, filed on Apr. 13, 2005.

(51) Int. Cl. C12S 3/00; C12S 13/00

(52) U.S. Cl. 435/267; 435/262

(57) ABSTRACT

Methods for inhibiting chlorine dioxide associated corrosion in industrial equipment by treating industrial equipment (e.g., pipes, washers and other metallic, e.g., stainless steel surfaces) or process streams in contact with industrial equipment with one or more haloperoxidases, preferably, a chloroperoxidase, in an amount effective to reduce chlorine dioxide associated corrosion.

### FIELD OF THE INVENTION

The present invention relates to methods for reducing chlorine dioxide associated corrosion using a haloperoxidase.

### BACKGROUND OF THE INVENTION

The direct cost of corrosion in industry is estimated to be about 220 billion dollars. Hays, G. 11^{th} International Symposium on Corrosion in the Pulp and Paper Industry, June 7-11, Charleston, S.C., 2004. For example, corrosion of parts and equipment is a major problem facing the pulp and paper industry due to the use of many aggressive chemicals during the pulp and paper making process. Among all of the chemicals used, chlorine dioxide has the highest redox potential and is one of the most corrosive chemicals used in industry.

Many pulp and paper mills use sodium hydroxide, sulphur dioxide or other reducing agents to remove residual chlorine dioxide from the pulp and paper process water to reduce chlorine dioxide associated corrosion. Sodium hydroxide, however, must be used at high concentrations to be effective and the high alkalinity can result in significant equipment an energy costs, as well as other detrimental effects, e.g., producing calcium carbonate scale. Although sulphur dioxide is fairly cost effective, it adds both safety hazards as well as potential corrosion problems itself. In addition, sulphur dioxide adds sulphur to the effluent, which may cause odor problems.

There is a need in the art for improved methods for controlling chlorine dioxide associated corrosion.

### SUMMARY OF THE INVENTION

The present invention relates to methods for inhibiting chlorine dioxide associated corrosion. In accordance with the present invention, chlorine dioxide associated corrosion may be inhibited in industrial equipment by treating industrial equipment (e.g., pipes, washers and other metallic, e.g., stainless steel surfaces) or process water in contact with industrial equipment with one or more haloperoxidases, preferably, a chloroperoxidase, in an amount effective to reduce chlorine dioxide associated corrosion. In an embodiment, the invention involves treating an industrial equipment or process water following chlorine dioxide treatment with one or more haloperoxidases, preferably, a cholorperoxidase, in an amount effective to deactivate residual chlorine dioxide.

In a preferred embodiment, the industrial process is a pulp and paper process. Preferably, the haloperoxidase treatment is applied following a chlorine dioxide treatment in the pulp and paper process, such as, following a chlorine dioxide bleaching stage, to remove residual chlorine dioxide.

### DETAILED DESCRIPTION OF THE INVENTION

Chlorine dioxide is well known as an algaecide, fungicide, germicide, deodorant, bleach, and general antiseptic. Chlorine dioxide is a strong oxidizer and is widely used as a bleaching and/or disinfectant agent. Chlorine dioxide is commonly used in the pulp and paper and water treatment industries. Chlorine dioxide is also used in considerably smaller quantities in treating agricultural produce and certain medical applications. Other industrial processes which use chlorine dioxide treatment include food and beverage production plants and confection (e.g., chewing gum) plants.

In a preferred embodiment, the present invention is applied to inhibit chlorine dioxide associated corrosion in a pulp and paper mill. Generally, pulp and paper mills include at least one chlorine dioxide treatment process, e.g., chlorine dioxide bleaching process stage.

Any industrial equipment or process water which is subject to chlorine dioxide associated corrosion may be treated with the haloperoxidase to inhibit or prevent chlorine dioxide associated corrosion. As used herein, industrial process stream refers to the industrial equipment (e.g., pipes, washers, etc.) or process water. Industrial equipment which is subject to chlorine dioxide associated corrosion includes any metallic surface (e.g., stainless steel) which comes in contact with chlorine dioxide and which is capable of being corroded by chlorine dioxide. Examples of industrial equipment which are commonly corroded by chlorine dioxide include pipes, washers, conduits and fittings.

The haloperoxidase is preferably applied immediately following the chlorine dioxide treatment stage, such as, by applying the haloperoxidase to the processing water containing the chlorine dioxide after the chlorine dioxide treatment is complete. More preferably, the haloperoxidase is applied to the processing water that is in contact with the industrial equipment which is subject to corrosion.

A haloperoxidase is intended to mean an enzyme selected from the group consisting of chloride peroxidase (EC 1.11.1.10), bromide peroxidase, and iodide peroxidase (EC 1.11.1.8). Examples of haloperoxidases include the Vanadium haloperoxidases, as disclosed in WO 95/27046. Haloperoxidases have been isolated from various organisms: mammals, marine animals, plants, algae, a lichen, fungi and bacteria (see Biochimica et Biophysica Acta 1161, 1993, pp. 249-256). It is generally accepted that haloperoxidases are the enzymes responsible for the formation of halogenated compounds in nature, although other enzymes may be involved.

Haloperoxidases have been isolated from many different fungi, in particular from the fungus group dematiaceous hyphomycetes, such as Caldariomyces, e.g., C. fumago, Altemaria, Curvularia, e.g., C. verruculosa and C. inaegualis, Drechslera, Ulocladium and Botrytis (see, e.g., U.S. Pat. No. 4,937,192). Haloperoxidase has also been isolated from bacteria such as Pseudomonas, e.g., P. pyrrocinia (see The Journal of Biological Chemistry 263, 1988, pp. 13725-13732) and Streptomyces, e.g., S. aureofaciens (see Structural Biology 1, 1994, pp. 532-537).

According to the present invention a haloperoxidase includes the haloperoxidase from Curvularia, in particular, C. verruculosa, such as, C. verruculosa CBS 147.63 or C. verruculosa CBS 444.70. Curvularia haloperoxidase and recombinant production hereof is described in WO 97/04102. Bromide peroxidase has been isolated from algae (see U.S. Pat. No. 4,937,192). Haloperoxidases are also described in U.S. Pat. No. 6,372,465 (Novozymes A/S).

In a preferred embodiment, the haloperoxidase is a chloroperoxidase (E.C.1.11.1.10). Chloroperoxidases are known in the art and may be obtained from Streptomyces aureofaciens, Streptomyces lividans, Pseudomonas fluorescens, Caldariomyces fumago, Curvularia inaequalis, and Corallina officinalis. A preferred chloroperoxidase is the chloroperoxidase from Caldariomyces fumago (available from SIGMA, C-0278).

The concentration of the haloperoxidase may be varied in order to achieve the desired chlorine peroxide reduction. According to the invention, the haloperoxidase will normally be added in a concentration of 0.0001 to 100 g of protein per g of ClO₂, preferably in a concentration of 0.001 to 10 g of enzyme protein per g of ClO₂, more preferably, in a concentration of 0.01 to 1 g of enzyme protein per g of ClO₂. The haloperoxidase is added in an amount effective to reduce residual chlorine dioxide (the chlorine dioxide concentration) present following a chlorine dioxide treatment process.

The haloperoxidase treatment may be applied at any appropriate temperature and pH (such as, pH 2-10), and such temperature or pH will also be selected based on the desired operating conditions. The temperature and pH should be suitable so that haloperoxidase has appropriate activity.

The treatment time will vary depending on the process conditions. Preferably, the treatment should be for at least 1 min, more preferably, at least 30 min, and even more preferably at least 1 hr.

### EXAMPLES

### Example 1

### Chlorine Dioxide Decomposition

5 mL of 0.4 mM ClO₂ was placed in several test tubes. The pH was adjusted to 2.5 by addition of H₂SO₄. Chloroperoxidase from Caldariomyces fumago (Sigma, C-0278) and haloperoxidase from Curvularia verruculosa (Novozymes) were added to each test tube. The solution was mixed and left at ambient temperature for 1 hour. The determination of the ClO₂ concentration was made with a UV-Vis spectrometer at 359 nm.

As shown in Table I, 5 mg of chloroperoxidase could completely decompose 5 mL of 0.4 mM of ClO₂. 0.4 mM is equivalent to 27 ppm of ClO₂, which is much higher than the residual ClO₂ normally seen during bleaching (0.02-0.5 ppm) in a pulp and paper mill. Haloperoxidase from Curvularia verruculosa also worked, but not nearly as effective as the chloroperoxidase. Laccases and non-haloperoxidases were also tested, but were not able to decompose ClO₂ even at very high dose (result not shown).

TABLE 1

| No. | Sample | Absorbency at 360 nm |
|---|---|---|
| 1 | Control (No enzyme) | 0.502 |
| 2 | 0.1 mg Chloroperoxidase | 0.408 |
| 3 | 0.5 mg Chloroperoxidase | 0.280 |
| 4 | 1 mg Chloroperoxidase | 0.203 |
| 5 | 5 mg Chloroperoxidase | 0 |
| 6 | 10 mg Chloroperoxidase | 0 |
| 7 | 200 mg haloperoxidase from Curvularia | 0.445 |
| | verruculosa | |
| 8 | 500 mg haloperoxidase from Curvularia | 0.415 |
| | verruculosa | |

### Example 2

### Metal Coupon Corrosion Test

Metal coupons (Alabama Specialty Products, Inc. (ASPI)), made of stainless steel (316 L) were placed in 2 flasks. 200 mL of 0.4 mM ClO₂ were added to each flask. Glass beads were placed in 2 flasks. The pH was adjusted to pH 2.5 with H₂SO₄. One flask was sealed with parafilm as the control. In addition, the flasks with the glass beads were also sealed with parafilm. To the other flask containing the metal coupons, 100 mg of chloroperoxidase from Caldariomyces fumago (Sigma, C-0278) was added, and the flask was then sealed. The flasks were stored at ambient temperature for 2 weeks. The metal coupons were rinsed with distilled water, and the number of corrosion pits generated were counted. Weight loss after drying overnight was then determined.

As shown in Table 2, chloroperoxidase effectively prevented the corrosion of metal coupons. The ClO₂ treated control sample showed significant pitting on the metal surface in 2 weeks of treatment.

TABLE 2

| Sample | Coupon surface | Treatment | No. | Weight |
|---|---|---|---|---|
| ID | Finish | (2 weeks) | of Pits | loss % |
| 1 | 120 grit | ClO₂ | 5 | 0.113 |
| 2 | 120 grit | ClO₂ | 6 | 0.132 |
| 3 | Glass bead | ClO₂ | 3 | 0.014 |
| 4 | Glass bead | ClO₂ | 2 | 0 |
| 5 | 120 grit | ClO₂ and | 0 | 0 |
| | | chloroperoxidase | | |
| 6 | 120 grit | ClO₂ and | 0 | 0 |
| | | chloroperoxidase | | |
| 7 | Glass bead | ClO₂ and | 0 | 0 |
| | | chloroperoxidase | | |
| 8 | Glass bead | ClO₂ and | 0 | 0 |
| | | chloroperoxidase | | |

What is claimed is:

1. A method for inhibiting chlorine-dioxide associated corrosion in an industrial process comprising contacting an industrial process stream comprising chlorine dioxide with one or more haloperoxidases in an amount effective to reduce the concentration of the chlorine dioxide.

2. The method of claim 1, wherein said industrial process is a paper and pulp process.

3. The method of claim 1, wherein said contacting is performed following a chlorine dioxide bleaching process.

4. The method of claim 1, wherein said contacting is performed following a chlorine dioxide disinfectant process.

5. The method of claim 1, wherein said one or more haloperoxidase is a chloroperoxidase.

6. The method of claim 5, wherein said chloroperoxidase is obtained from Streptomyces aureofaciens, Streptomyces lividans, Pseudomonas fluorescens, Caldariomyces fumago, Curvularia inaequalis or Corallina officinalis.

7. The method of claim 5, wherein said chloroperoxidase is obtained from Caldariomyces fumago.

8. A method for inhibiting chlorine-dioxide associated corrosion in a pulp or paper process comprising contacting a process stream comprising chlorine dioxide with one or more haloperoxidases in an amount effective to reduce the concentration of the chlorine dioxide.

9. The method of claim 8, wherein said contacting is performed following a chlorine dioxide bleaching process.

10. The method of claim 8, wherein said one or more haloperoxidase is a chloroperoxidase.

11. The method of claim 8, wherein said chloroperoxidase is obtained from Streptomyces aureofaciens, Streptomyces lividans, Pseudomonas fluorescens, Caldariomyces fumago, Curvularia inaequalis or Corallina officinalis.

12. The method of claim 8, wherein said chloroperoxidase is obtained from Caldariomyces fumago.
